(19) United States
(12) Patent Application Publication
(10) Pub. No.: US 2005/0034591 A1
(43) Pub. Date: Feb. 17, 2005

(54) Roll-up electronic piano

(76) Inventor: Young-So Chang, Yongin-Si (KR)

Correspondence Address: TAFT, STETTINIUS & HOLLISTER LLP, SUITE 1800, 425 WALNUT STREET, CINCINNATI, OH, 45202-3957, US

(21) Appl. No.: 10/888,270

(22) Filed: Jul. 9, 2004

(30) Foreign Application Priority Data
Aug. 7, 2002 (KR) 20-2002-0023572

(51) Int. Cl. G10H 1/12; G10H 5/00; G10H 3/14

(52) U.S. Cl. 84/730

(57) ABSTRACT

The present invention relates to an electronic piano including a roll-up keyboard. The roll-up electronic piano comprises a keyboard including piezoelectric material and a controller with a sound chip that controls and amplifies electrical piezoelectric signals. The roll-up electronic piano is easy to carry due to its ultra-light weight and small size. Particularly, the roll-up electronic piano produces a similar tone to that of a real piano. The roll-up electronic piano can be conveniently used in music classes and enhance the efficiency of learning. In addition, the roll-up electronic piano can be played anywhere without being restricted by space and can be controlled by a wireless method.

### CROSS-REFERENCE TO RELATED APPLICATIONS

This application is a continuation that claims priority under 35 U.S.C. §120 of Patent Cooperation Treaty Application Serial No. PCT/KR2003/001589 filed on Aug. 7, 2003, entitled “ROLL-UP ELECTRONIC PIANO” which claims priority to Korean Patent Application Serial No. 20-2002-0023572 filed on Aug. 7, 2002, entitled “ROLL-UP ELECTRONIC PIANO.”

### FIELD OF THE INVENTION

The present invention relates to an electronic piano including a roll-up keyboard and, more particularly, to a roll-up electronic piano whose tone is similar to that of a real piano and is much smaller and lighter than existing electronic pianos. The electronic piano according to the present invention may comprise a border member that includes a piezoelectric material capable of performing on/off functions, a keyboard whose cover is made of a silicon material and is capable of being folded/unfolded, and a control part that controls and amplifies piezoelectric signals, which can be separated from the keyboard, and can perform wire/wireless send/receive functions.

### BACKGROUND

Children may individually have practical training using keyboard instruments similar to a piano in a music class. A typical personal keyboard instrument for use by children includes a hard keyboard with about two octaves that is played through insufflating air by mouth. As an example, Korean utility model patent publication No. 88-13187 discloses an electronic piano using an electronic circuit design with an IC (integrated circuit). However, it is impossible for this electronic piano to control the volume of sound according to the strength of force pressing on the keyboard. Moreover, the electronic piano has only on/off functions. More advanced keyboard instruments may be connected to a computer, but these instruments also include simple on/off functions.

In addition, the above-mentioned keyboard instruments are cumbersome to carry because of the large size thereof and provide little help to further a musical education due to poor effects of usage and function. In other words, it is difficult for the existing keyboard instruments to sound similar in tone to that of a real piano and to represent the strength of the sound.

U.S. Pat. No. 6,259,006 discloses an electronic piano providing some means capable of coping with the above-identified problems. The electronic piano is portable and foldable, has a small size and is relatively lightweight, and can be connected to a computer. Moreover, the tone of the electronic piano is similar to that of a real piano. However, the electronic piano has a problem that when the keyboard is folded with the power on, the keys pressed may generate a noise. Moreover, if the user does not turn off the power and rolls up the keyboard carelessly, the keyboard may continue to generate the noise for a long time without being perceived by the user because the electronic piano has headphones instead of loudspeakers. Thus, this may have an electrically damaging effect on the inside electric devices of the electronic piano.

The above-mentioned U.S. Patent has another problem in its method of generating sounds. A real piano does not have a vibrato effect, or a tremulous or pulsating effect produced by minute and rapid variations in pitch. However, in an electronic piano without a time period for a piezoelectric material to perceive input, if a user first presses a key of the keyboard and, then, changes the pressure of his/her finger, the vibrato effect may occur. In addition, if the user presses slowly and deeply on the keyboard, the pressure on the piezoelectric material gradually increases and, therefore, the volume of sound also gradually increases because an electric current increases gradually. Conversely, if the user slowly relaxes the pressure of his/her finger, the pressure on the piezoelectric material gradually decreases and, therefore, the volume of sound also gradually decreases because an electric current gradually decreases. This may become a considerable problem in reproducing a tone of a real piano. As shown in FIG. 1, a real piano generates sound by a hammer (200) hitting a string (300) when a user presses a key (100). Thus, when the user presses a key once, the hammer hits the string once and the vibrato effect cannot occur. The vibrato effect is different from tremolo as a rapid repetition of a note. For example, the vibrato of string instruments occurs by means of fast movement of a finger on a string and the vibrato of wind instruments, by means of controlled breathing.

The electronic piano according to the above-mentioned U.S. Patent, which has an imperfect operating construction of piezoelectric material, can embody a similar tone to that of a real piano to some degree, but cannot embody a sound effect that is produced by a hammer hitting a string. Moreover, although the above-mentioned U.S. Patent can embody a tone of a real piano through using a simple contact method instead of using a piezoelectric material, the simple contact method cannot control the strength of the tone. In other words, it cannot embody sound effects according to the strength of pressing a key. The U.S. Patent can damp or sustain a sound by using pedals, but cannot embody an effect strengthening the sound.

Another disadvantage of the conventional foldable electronic pianos is that a user may not play the electric piano in a location having a narrower width than the length of the keyboard. Generally, a desk in a classroom has a length of about 60 cm and, therefore, the keyboard with more than four-octaves whose keys have the same size as those of a real piano endows some trouble in rolling it out on the desk. In other words, some section of the keyboard drops downward from the top of the desk, and, therefore, it is difficult to utilize all the keys of the electric piano.

### SUMMARY

Accordingly, the present invention is directed to a new roll-up electronic piano that substantially obviates one or more limitations and disadvantages of the related art.

It is an object of the present invention is to provide a roll-up electronic piano having a small size attributable, at least in part, to a foldable keyboard. The electronic piano can produce sounds according to the strength and the duration of pressure in pressing a key and can embody a similar tone to that of a real piano by preventing the vibrato effect. Still further, the electronic piano can be controlled through wired or wireless communications and be played even in a narrow space because it includes a removable structure capable of separating the keyboard from the control part, and can be used conveniently in a music class for children and students due to its small size and lightweight.

To achieve the objects and other advantages of the present invention, as embodied and broadly described herein, the invention provides a roll-up electronic piano comprising a keyboard made of piezoelectric material and a control part which can control and amplify electrical piezoelectric signals.

The keyboard of the electronic piano according to the present invention produces a signal by electromotive force through a piezoelectric polymer film such as poly vinylidene fluoride (hereinafter referred to as “PVDF”) or a piezoelectric fiber when a user presses a key of the keyboard. The piezoelectric polymer film generates a voltage according to the strength and the duration of impact. The generated signals are controlled and amplified in the control part with a sound chip and thereafter directed to a speaker.

The keyboard of the present invention has 4-8 octaves, and can be rolled up to form a cylinder. The keyboard comprises a coupling member for connection with the control part. The coupling member is made of flexible material that can mechanically withstand strains produced by folding and unfolding operations. In addition, white keys and black keys of the keyboard are designed in accordance with the standard configuration of a real piano. Inside the keyboard is a piezoelectric polymer film such as PVDF or a piezoelectric fiber that generates a piezoelectric electromotive force corresponding to each key of the keyboard. The covering of the keyboard, except the coupling member, is made of flexible rubber. Therefore, the electronic piano of the present invention can be easily rolled up and is portable. The control part comprises an electronic circuit design including a microprocessor and a sound chip.

In the electronic piano of the present invention, a noise is not generated although the keyboard is rolled up, the power on, and the keys are depressed because the border member of the keyboard part comprises a second piezoelectric material other than the piezoelectric material contained inside the keyboard. The second piezoelectric material generates a voltage when it is bent. If the piezoelectric material is bent excessively and the resulting voltage is higher than an adequate voltage, the control part produces a signal based on the voltage which controls the electrical power. Therefore, the roll-up electronic piano can obviate noise produced from depression of the keys of the keyboard when folded without requiring the power to be turned off.

The roll-up electronic piano can produce a similar tone to that of a real piano because the present invention can eliminate the vibrato effect. One of the general characteristics of the piezoelectric material is a change in voltage due to a change of resistance by pressure. Based upon the change in voltage, the volume of sound generated from a sound chip changes. An electronic piano according to a prior art may sound like a real piano tone indicative of a hammer hitting a string, but only when a key is pressed using a uniform force. Although a user may not become aware of the difference while playing simple musical notes, he/she may notice the difference when playing complex musical notes. For example, if a user's first finger presses a first key while a second finger continuously presses a second key, it is difficult for the first finger to continuously press the first key with uniform force. To obviate this problem, the keyboard of the electric piano according to the present invention has a function to detect the start of applying pressure and a function to detect a change in voltage in the piezoelectric material for a fixed time, thereby preventing the vibrato effect. That is, the start of transformation of the piezoelectric material at more than a fixed pressure is perceived as the contact of a finger on a key, and a voltage immediately after the key is pressed at a desired force is obtained while a change in voltage generated thereafter is not obtained. Then, if the pressure on the key is diminished to less than a fixed pressure and the piezoelectric material is restored to the original state, the keyboard finishes generating a sound. Therefore, in playing the electronic piano, an unnecessary vibrato effect can be prevented.

The roll-up electronic piano according to the present invention can be played effectively in a narrow space because it includes a function controlling the number of octaves of the keyboard thereby eliminating the inconvenience of detaching the keyboard.

In addition, the roll-up electronic piano is divided into the control part and the keyboard and can be controlled by a wire or a wireless method. When the electronic piano is divided into the control part and the keyboard, signals according to a change in voltage generated from the keyboard is transformed to a digital signal and the digital signal along with a unique ID value (a unique number of an apparatus) are transmitted to the control part. The control part identifies the ID value received and generates sounds according to the digital signals received.

The covering of the keyboard is made of a flexible material such as rubber or, more preferably, silicon rubber. The silicon rubber has good thermal endurance, cold resistance, and moisture resistance.

If a (printed circuit board) PCB is used instead of the piezoelectric material and the wireless function is omitted, the roll-up electric piano with sufficient functions can be produced at a low cost.

The roll-up electronic piano according to the present invention, may be connected to peripheral devices such as a personal computer that can store and reproduce a record of playing as a music file by transforming analog signals into digital signals.

### BRIEF DESCRIPTION OF THE DRAWINGS

FIG. 1 is a diagram illustrating a principle of sound generation in a real piano;

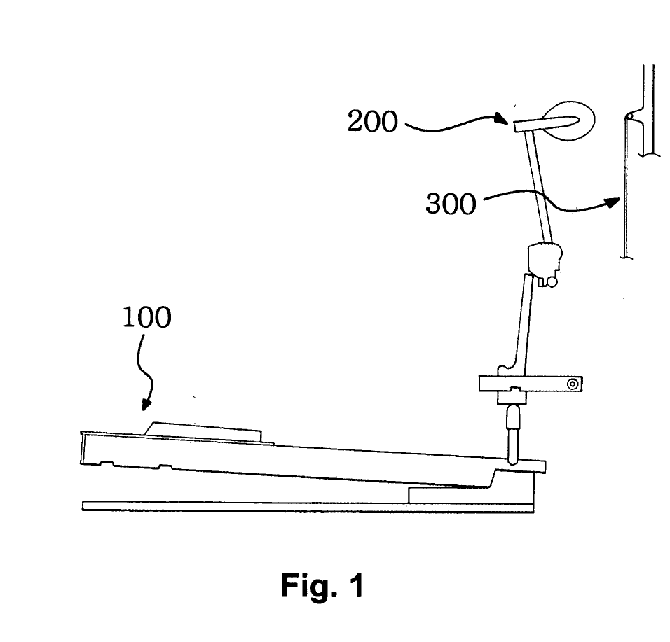

FIG. 2 is a block diagram describing an exemplary electronic piano according to the present invention;

FIG. 3a is a cross-sectional view of a keyboard according to an exemplary embodiment of the present invention;

FIG. 3b is a cross-sectional view of another exemplary keyboard in accordance with the present invention;

FIG. 3c is a cross-sectional view of a still further exemplary keyboard in accordance with the present invention;

FIG. 4 illustrates an exemplary removable structure of a roll-up electronic piano in accordance with the present invention;

FIG. 5 illustrates an exemplary roll-up electronic piano with pedals in accordance with the present invention;

FIG. 6 illustrates an exemplary exterior of a roll-up electronic piano in accordance with the present invention;

FIG. 7 illustrates, in a cross-sectional view, an exemplary folded state of an exemplary roll-up electronic piano in accordance with the present invention;

FIG. 8 illustrates, in a perspective view, another exemplary folded state of an exemplary roll-up electronic piano in accordance with the present invention; and

FIG. 9 is a perspective view of an even further exemplary roll-up electronic piano in accordance with the present invention.

### DETAILED DESCRIPTION

Reference will now be made to the exemplary embodiments of the present invention that are illustrated in the accompanying drawings.

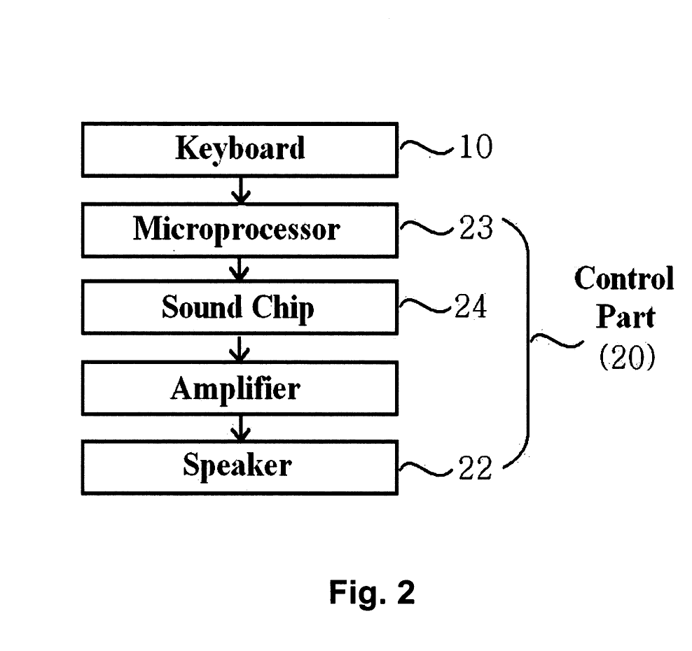

Referring to FIG. 2, a keyboard (10) outputs a signal attributable to an electromotive force using poly vinylidene fluoride (PVDF) or a piezoelectric fiber with piezoelectric characteristics based on the strength and duration of pressure exerted by a user. That is, while an electric current is applied into the PVDF, the PVDF generates a voltage according to the strength and the duration of the pressure. The outputted signal is amplified in the control part (20) having a sound chip (24) and then, sound comes out through a speaker (22). The sound chip may provide hundreds of tones.

In addition, the sound chip (24) according to the present invention can provide the same sound effect as a real piano. The various magnitudes of sound generated when a key of a real piano is pressed at various pressures are logged and the logged data is compared to a voltage from the piezoelectric material (15), which is generated when a key of keyboard (10) of the electronic piano is pressed. Then, the logged data corresponding to the voltage is stored in the sound chip (24) to generate the same magnitude of sound with that of the real piano.

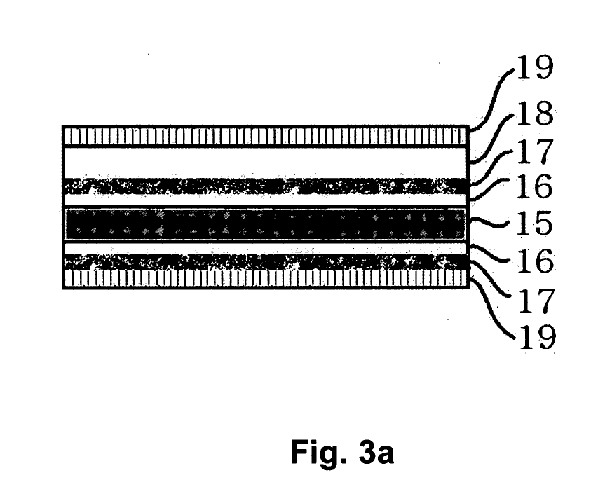

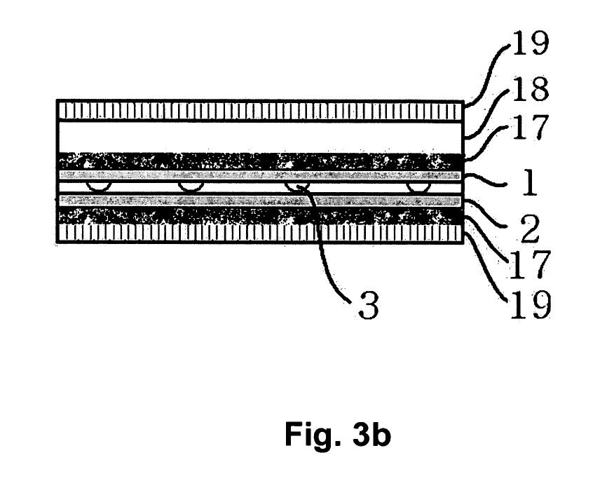

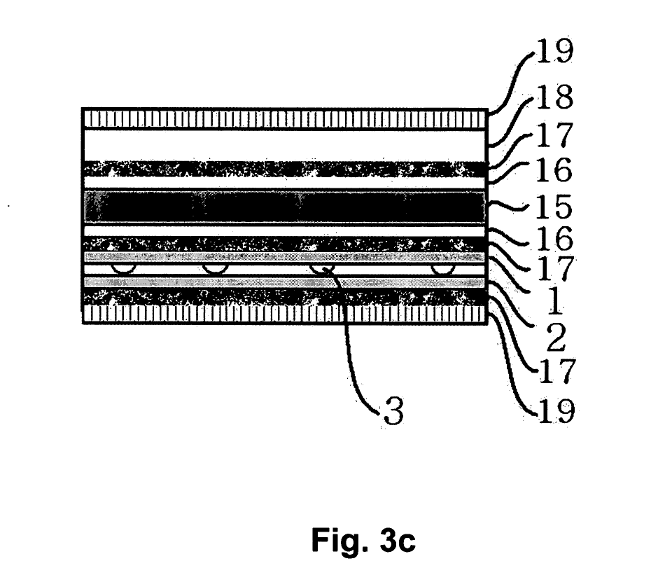

In detail, inside the keyboard (10) is the piezoelectric material perceiving pressure, which is enclosed by a conducting pattern film, and an insulator is formed to enclose the conducting pattern film. Referring to FIG. 3a, upper and bottom conducting pattern films (16) are positioned on and underneath the piezoelectric material (15), and upper and lower insulators (17) are positioned to enclose the conducting pattern films (16). Then, a shock-absorbing member (18) is positioned on top of the upper insulator (17). The covering of the keyboard (10) is made of silicon rubber (19). The insulators (17) suppress static electricity that may be generated on the surface of the keyboard (10).

In the above-mentioned keyboard structure, the voltage generated when a key of the keyboard (10) is pressed is controlled by a microprocessor (23) of the control part (20). The signal controlled by the microprocessor (23) is converted into sound through the sound chip (24), an amplifier, and the speaker. When a user presses a key of the keyboard (10), pressure is applied to the silicon rubber (19) and the pressure is transmitted to the shock-absorbing member (18). The shock-absorbing member (18) does not transmit the pressure to the insulator (17) if the pressure is less than a predetermined value. That is, in case of merely placing a finger on the keyboard the shock-absorbing member (18), made of a soft material, absorbs the pressure to suppress the generation of a sound. In addition, the shock-absorbing member (18) may be formed in various densities and thicknesses to simulate the touch of a real piano. If the shock-absorbing member (18) is excessively thin or soft, the keyboard may reduce the simulated feeling of pressing a key of a real piano. If the shock-absorbing member (18) is excessively thick, the keyboard may not be easily rolled up. If the shock-absorbing member (18) is excessively hard, more pressure may be required to press the key than for a real piano. Thus, the shock-absorbing member (18) should be made of a material with an adequate density and thickness.

If adequate pressure is applied on the shock-absorbing member (18), the insulator (17) disposed underneath the shock-absorbing member (18) is pressed and then, the conducting pattern film (16) underneath the insulator (17) is pressed to transmit the pressure to the piezoelectric material (15). The conducting pattern film (16) is a device operative to transmit the change in voltage of the piezoelectric material (15) to the control part. The pressure transmitted transforms the piezoelectric material (15), thereby changing the resistance of the piezoelectric material and also changing the voltage.

Then, the microprocessor (23) in the control part generates a first signal. Even after the microprocessor generates the first signal, the pressure continues to increase until it reaches a desired strength. If the desired strength is transmitted completely, the transformation rate of the piezoelectric material (15) is diminished and the microprocessor perceives a decrease in the change in voltage and resistance. A second signal is generated after detecting the desired strength.

The time interval between the first and second signals corresponds to a period starting when a user first presses a key of a real piano to when he/she finishes to press the key with the desired strength. That is, the time interval corresponds to a period starting when a user presses a key of a real piano to when a hammer in the real piano hits a string. The microprocessor (23) controls the sound chip so as not to generate sound for the time interval between the first and the second signal. The microprocessor (23) generates sound after the second signal is created. In addition, to prevent the vibrato effect brought about by a minute change in pressure after completely pressing to the desired strength, the magnitude of the change in voltage corresponding to the second signal is compared to the data stored in the sound chip (24) beforehand to generate only a single adequate sound. Therefore, a single sound is generated for each press of a key. The sound generated by the second signal is set to decrease according to the strength of the pressure exerted by a user, just like a real piano whose sound slowly decreases while the user continues to press the key. In addition, the sound is set up to stop sounding immediately after the user removes his finger from the key, just the same as a real piano.

Accordingly, the present invention can prevent variable electronic sound that may be generated from existing electronic keyboards, and generate the clear sounds of a real piano. Examples of the variable electronic sounds include a crescendo effect where the volume of sound gradually increases during a time interval between the first and second signal, a vibrato effect that may be generated because of a user's fingers pressing a first key while continuously pressing another key, and a decrescendo effect where the volume of sound gradually decreases during an instant time interval in which the user's finger is removed from the key.

The covering of the keyboard is made of a flexible rubber, preferably, silicon rubber so that the keyboard can be rolled up. Silicon rubber has good heat resistance, cold resistance, and moisture resistance. In addition, a pattern imprinted on the surface of the silicon rubber stands well. The present invention includes reforming the surface of the silicon rubber to facilitate mounting portions of the silicon rubber to one another.

A method of reforming the silicon rubber comprises the steps of injecting an inert gas into a vacuum chamber, converting the inert gas into a plasma state by applying plasma potential so that the inert gas can move very rapidly, and forming fine grooves on the surface of the silicon rubber using the inert gas in its plasma state. An adhesive infiltrates into the fine grooves so that the upper plate of the keyboard covering made of silicon rubber can adhere to the lower plate of the keyboard covering. By reforming of the surface of the silicon rubber, an inexpensive general adhesive can be used to connect the upper and lower plates of the keyboard covering instead of an expensive adhesive adapted for bonding to silicon rubber. The reformed silicon rubber can maintain adhesive force with repeated folding and unfolding operations.

The shape of a keyboard is printed on the upper plate of the keyboard covering. Here, another advantage of the reformed silicon rubber with fine grooves is that when white keys and black keys are printed on the upper plate of the keyboard covering, the number of printing sequences can be markedly reduced because ink can easily infiltrate into the silicon rubber through the fine grooves. For example, in using a typical silicon rubber, white ink is applied three times and black ink is applied twice during printing. On the other hand, in using the reformed silicon rubber, white ink is applied twice and black ink is applied once during printing. In addition, a good printing quality can be achieved even with general inks instead of expensive inks.

Inside the border member of the keyboard (10) is a second piezoelectric material. The second piezoelectric material is operative to obviate the keyboard from generating a loud noise when it is rolled up with the power on. If the second piezoelectric material is bent excessively to more than a particular angle due to a folded keyboard or a careless usage, it is transformed to change its resistance, thereby changing the voltage and, ultimately, the power is turned off. In another exemplary embodiment, the voltage generated from the piezoelectric material may turn off the power or the power may be turned on when the piezoelectric material is unfolded to less than a particular angle. Such a power on/off method includes on/off only by a power switch; on/off by a power switch and off by the second piezoelectric material in the border member; on/off by a power switch and on/off by the second piezoelectric material in the border member; and, on/off only by the second piezoelectric material in the border member.

The roll-up electronic piano according the present invention can be played in a narrow space because the control part (20) has a button that can control an active range of the keyboard (10). The keyboard (10) may have an arbitrary octave range, preferably 3-8 octaves. The control part (20) can choose the active range of the keyboard (10) according to the availability of space. For example, the active range of the keyboard may be selected from 1-8 octaves, based on an octave unit or a key unit, starting from the control part (20). The active range of the keyboard may also be arbitrarily selected regardless of the vicinity of the control part based on the octave unit or the key unit. Therefore, the roll-up electronic piano can be played conveniently in a narrow space with a simple operation of a button compared to the inconvenience of a conventional electronic piano whose keyboard part may be detached or attached on occasion.

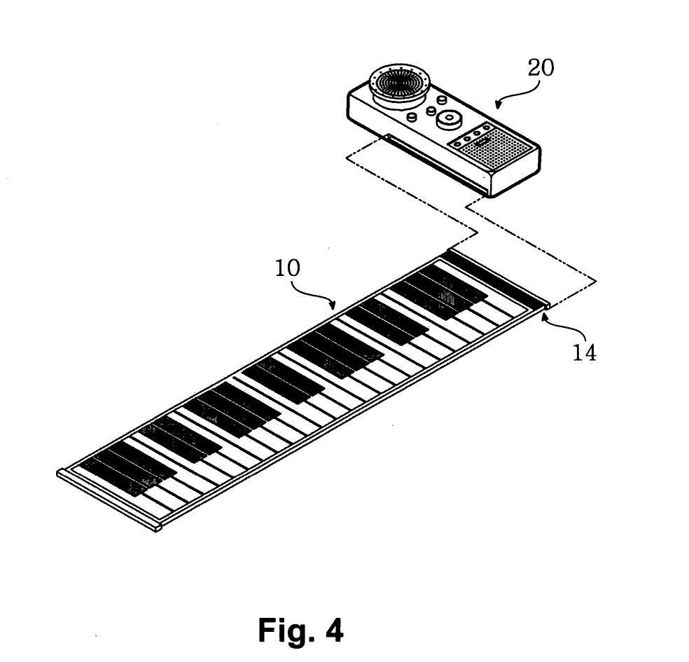

Referring to FIG. 4, the roll-up electronic piano of the present invention has a removable structure where the control part and the keyboard are separated and can be controlled through a wired or wireless method. In controlling the electronic piano through a wireless method, there are several additional elements that may be included such as a separate power supply unit for the keyboard, A/D converter which converts changes in voltage generated from the keyboard (10) into a digital signal, a signal processing part that adds a unique ID value (i.e., a unique number of an apparatus) to the digital signal, and a transmitting part that transmits the signal with the unique ID value. The power supply unit, A/D converter, signal processing part, and transmitting part may be installed in a coupling member (14). The control part (20) also has a receiver that receives the signal from the keyboard (10). The signal received in the control part is perceived after the microprocessor (23) identifies the unique ID that is included in the signal to prevent errors that may occur when a plurality of people play electronic pianos simultaneously.

The roll-up electronic piano of the present invention may comprise different components according to the wired or wired/wireless simultaneous method. Using the wired method in which the keyboard (10) is coupled to the control part (20), the sound is generated by an electric analog signal. Using the wired/wireless simultaneous method, the sound is generated by a process of converting the analog signal into the digital signal. Therefore, the necessary components are adequately selected according to which signal is selected from the digital and analog signals.

By using the digital signal, the electronic piano can be connected to peripheral devices such as a personal computer via a USB connection in order to record the playing as a music file. In addition, using the wireless method that produces a digital signal, software may be used as the control part in addition to or instead of hardware. For example, a program used as the control part can be downloaded from an Internet website. In this method, a receiver, which receives signals from the keyboard, should be included. In circumstances where a personal computer is used in place of the control part, the program used as the control part may be downloaded from an Internet website and, then, a receiver coupled to a USB receiving board associated with the computer receives the signals transmitted from the keyboard to generate sound.

When personal telecommunications devices such as a cellular phone and a personal digital assistance (PDA) are used as the control part, a program used as the control part may be downloaded from an Internet website and, then, a receiver coupled to an interface in the personal telecommunications device receives the signals transmitted from the keyboard to-generate sound. In addition, by installing the program used as the control part in external telecommunications equipment, the roll-up electronic piano may be utilized more effectively.

The roll-up electronic piano may have a simpler structure using a PCB (printed circuit board). The PCB is relatively inexpensive and can provide a simple constitution although it may not embody the strength of sound compared to the method using piezoelectric material and a microprocessor. For example, the roll-up electronic piano comprises a keyboard including two plates of PCB film and silicon rubber and a control part that includes a simple sound chip without a microprocessor.

Referring to FIG. 3b, a plurality of protrusions (3) made of insulating material are formed at a lower surface of an upper PCB (1) to maintain a distance between the upper (1) and a lower (2) PCB when a key of the keyboard is depressed. When a key is depressed, pressure is first applied to the keyboard covering made of silicon rubber (19) and transferred to a shock-absorbing member (18). If the pressure is less than an adequate value, the shock-absorbing member may not transfer the pressure received to the insulator (17). That is, if a user lightly touches the keyboard with his/her finger, the shock-absorbing member made of a soft material absorbs the pressure to suppress the generation of sound. If the pressure transmitted to the shock-absorbing member is more than an adequate value, the pressure is transferred to the insulator (17) and the PCB in sequence. The upper and lower PCBs are connected to the sound chip through a metal interconnection for each key. The PCBs (1 and 2) can maintain flexibility and elasticity during repeated folding and unfolding operations and generate sound by an electric current that flows when the upper PCB comes in contact with the lower PCB.

In another exemplary embodiment, the electronic piano may comprise the piezoelectric material and the PCB together. Referring to FIG. 3c, a keyboard (10) comprises a shock-absorbing member (18), insulator (17), piezoelectric material (15), an upper PCB (1), and a lower PCB (2). Such a keyboard structure may simplify functions of the microprocessor (23) and the sound chip (24) compared to the method using only electrical signals and detecting the strength of pressure exerted upon a key. With respect to a correlation between the piezoelectric material (15) and the microprocessor (23), if only the piezoelectric material (15) is used, generation of sound is controlled by pulse signals according to time using a first and second signals. However, if the piezoelectric material and the PCB are used together, the first signal is not required. That is, only one signal is generated because the voltage generated from the piezoelectric material (15) is reduced after an electric current flows between the upper and the lower PCBs that replaces both first and second signals. As soon as the upper PCB becomes in contact with the lower PCB, the magnitude of the voltage from the piezoelectric material is perceived and a signal to determine the volume of sound is generated.

A real piano may include two or three pedals. The pedals control the strength and the length of sound being related to movement of the user's fingers. There are several types of pedals such as a damper pedal, a soft pedal, a sostenuto pedal, and a muffler pedal. The damper pedal raises all the dampers (the felt pads which rest on the strings to stop the sound) and lets all the strings vibrate without having to hold the keys down. If a user presses down on the damper pedal, the dampers are removed from the strings and sustain the vibration of the strings long after the user removes his/her finger from a key, thereby providing a larger volume of sound, an abundant timbre, and a rich tone. If the user presses down on the soft pedal, hammers move toward the strings to shorten the distance that the hammers move to hit the strings, thereby producing soft sounds. The sostenuto pedal is a type of selective sustain pedal found in acoustic grand pianos. It sustains only the sounds of keys that were pressed at the time the pedal was engaged-and all other notes -remain unchanged. If the user presses down on the muffler pedal, the felt pads are positioned between the hammers and the strings so that the hammers hit the strings behind the felt pads thereby substantially reducing the volume of sound.

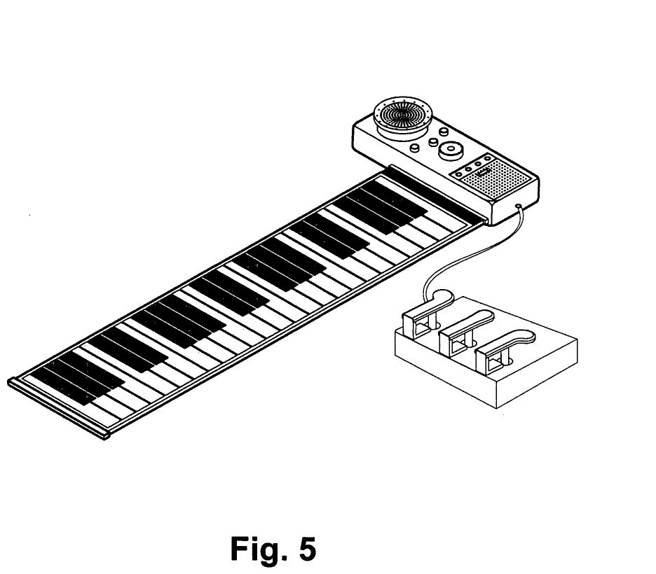

Referring to FIG. 5, the various functions of pedals in a real piano can be embodied in the roll-up electronic piano of the present invention by connecting the pedals to the sound chip. The pedals can be selectively set up in accordance with types of pianos, for example, grand pianos or upright pianos and be connected to the control part.

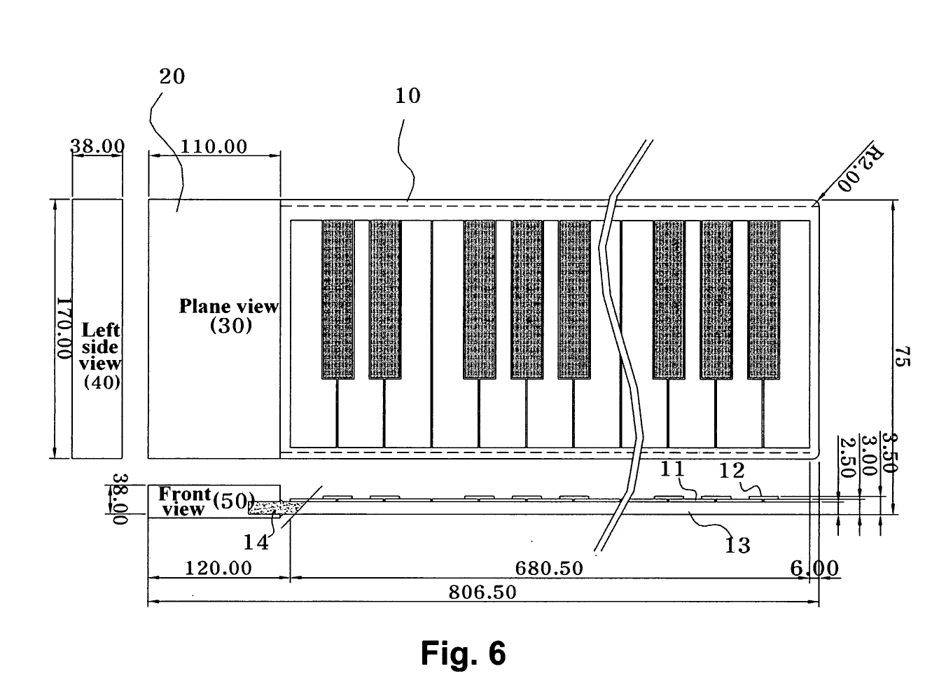

FIG. 6 illustrates, in a plane view (30), a left side view (40), and a front view (50) of the exterior of the roll-up electronic piano according to the present invention. In the plane view (30), the keyboard (10) comprises four octaves with a length of 690.5 mm and a width of 170.0 mm and, therefore, it has an adequate size for use in a music class. In the front view (50), the keyboard (10) comprises white keys (11) with a height of 0.5 mm, black keys (12) with a height of 0.5 mm from the white keys, and a keyboard pad (13) with a height of 2.5 mm. Therefore, the keyboard has thickness of 3.5 mm so as to be easily foldable and portable. The height and length of other parts, as well as the height of black keys (12), can be arbitrarily adjusted. The coupling member (14) that connects the keyboard (10) with the control part (20) can firmly maintain the coupling with repeated folding and unfolding operations. The control part (20) has an exemplary length of 120.0 mm, a width of 170.0 mm, and a height of 38.0 mm. The white keys and black keys are designed in accordance with the standard configuration of a real piano. Inside the keyboard (10) is a piezoelectric polymer film to create a piezoelectric electromotive force corresponding to each key of keyboard. The control part (20) comprises a circuit including an electronic circuit design and a button controlling the volume of sound.

Particularly, a standard volume corresponding to the volume of a real piano is marked around the volume button, thereby maximizing the effect of musical education. In addition, a music stand may be additionally positioned on the border member of the keyboard at a location where the music stand does not obstruct the function of the second piezoelectric material.

The sound chip of the roll-up electronic piano can produce hundreds of tones. The sound chip has a database for tones and sound effects of hundreds of instruments such as pianos, guitars, flutes, saxophones, violins, mandolins, harps, and so on as well as data related to tones and the strength of sound according to the pressure exerted while playing a real piano. Particularly, it is important to set up additional functions according to tones selected. For example, when selecting a violin tone, an additional function is set up in the microprocessor to not generate a signal due to the change of voltage in the piezoelectric material as in the electronic piano because a real violin generates sound not by hitting strings with hammers but by rubbing strings with a fiddle bow.

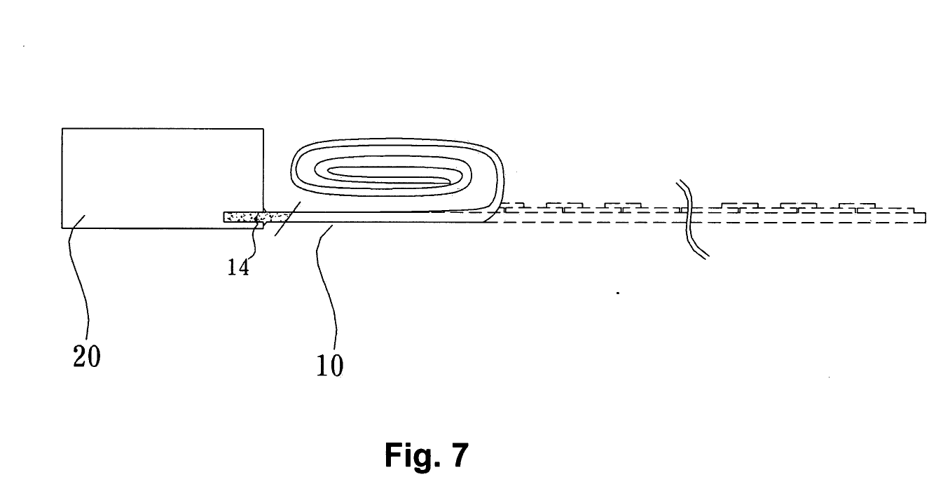

FIG. 7 illustrates, in a cross-sectional view, a folded state of the roll-up electronic piano according to the present invention. Inside the keyboard (10) part, except the coupling member (14), is a soft piezoelectric polymer film or a piezoelectric fiber and the keyboard pad (13) is made of silicon rubber so that the keyboard can be easily rolled up.

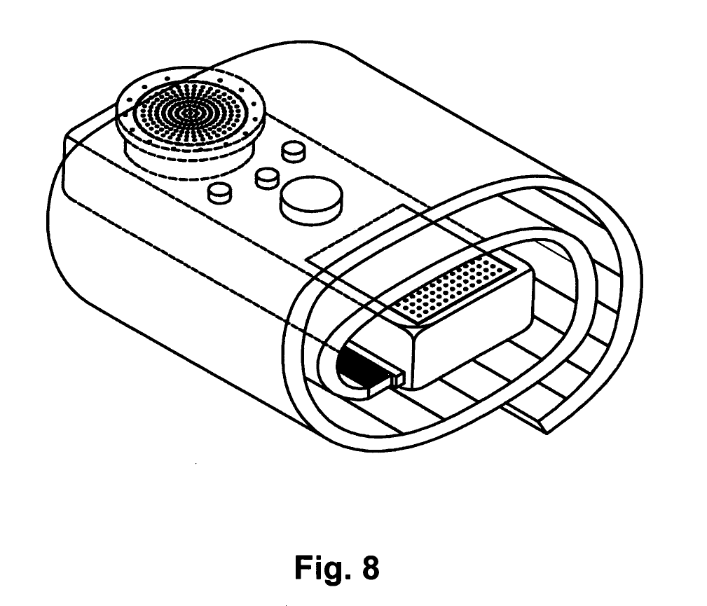

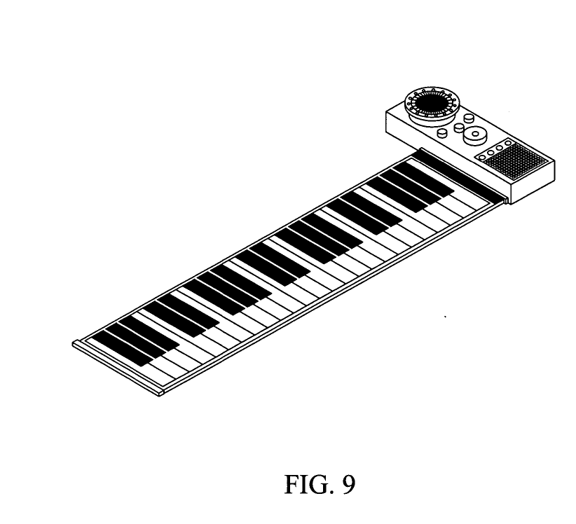

FIG. 8 illustrates, in a perspective view, a folded state of the roll-up electronic piano according to the present invention. FIG. 9 is a perspective view of the roll-up electronic piano according to the present invention.

The roll-up electronic piano according to the present invention can simultaneously generate six notes or more and can be arbitrarily designed to utilize 3-4 octaves in a music class and 8 octaves for general use.

1. A method of generating sound in a roll-up electronic piano comprising the steps of:
pressing a key of a keyboard to exert a force on a shock-absorber;
generating a first signal in response to a first voltage change caused by a transformation of a piezoelectric material, the piezoelectric material being transformed by the force transmitted from the shock-absorber, where the shock-absorber transmits the force to the piezoelectric material if the force is more than a predetermined magnitude;
generating a second signal in response to a second voltage change caused by the transformation of the piezoelectric material subsequent to the first voltage change; and
generating a sound with a predetermined volume in response to the first signal and the second signal.

2. A method of generating sound in a roll-up electronic piano comprising the steps of:
pressing a key of a keyboard to exert a force on a shock-absorber;
applying an electric current between printed circuit board plates positioned adjacent to a piezoelectric material when the force transmitted to the shock-absorber is transmitted to the piezoelectric material, the printed circuit board plates including a set of electrical contacts corresponding to each key of the keyboard, where the shock-absorber transmits the force to the piezoelectric material if the force is more than a predetermined magnitude; and
generating a sound with a predetermined volume in response to the first signal and the second signal.

3. A method of generating sound in a roll-up electronic piano comprising the steps of: pressing a key of a keyboard to exert a force on a shock-absorber;
applying an electric current between printed circuit board plates with a set of electrical contacts corresponding to each key of the keyboard if the force is more than the shock-absorber can wholly absorb; and
generating a sound in response to the application of the electric current between the printed circuit board plates.

4. A roll-up electronic piano comprising:
a keyboard comprising:
a piezoelectric material having an electrical resistance that changes in response to a force applied thereto,
an upper conducting film and a lower conducting film in electrical communication with the piezoelectric material and a controller,
a shock-absorber transmitting the force to the piezoelectric material if the force is more than a predetermined magnitude;
where the controller is operative to generate a first signal in response to a first voltage change resulting from transformation of the piezoelectric material and a second signal in response to a second voltage change resulting from transformation of the piezoelectric material, where the first voltage change precedes the second voltage change, and where the second signal is utilized to generate a sound signal having a predetermined volume corresponding to the force applied to the piezoelectric material.

5. The roll-up electronic piano of claim 4, wherein the controller includes a microprocessor that calculates a magnitude of the force applied to the piezoelectric material based on the second voltage change, and a sound chip that generates the sound signal with the predetermined volume corresponding to the magnitude of the force.

6. The roll-up electronic piano of claim 5, wherein the sound chip includes a database associating a particular volume of the sound signal with a corresponding magnitude of the force.

7. The roll-up electronic piano of claim 4, wherein the controller includes a database having tones of instruments, where the instruments include at least one of a piano, a guitar, a flute, a saxophone, a violin, a mandolin, and a harp.

8. The roll-up electronic piano of claim 4, wherein the upper conducting film and the lower conducting film sandwich the piezoelectric material therebetween.

9. The roll-up electronic piano of claim 8, wherein an upper insulator is mounted to the upper conducting film and a lower insulator is mounted to the lower conducting film.

10. The roll-up electronic piano of claim 4, further comprising a cover forming an exterior aspect of the keyboard.

11. The roll-up electronic piano of claim 10, wherein the cover is fabricated from silicon rubber.

12. The roll-up electronic piano of claim 10, wherein a surface of the cover includes fine grooves fabricated using at least in part the steps of:
injecting an inert gas into a vacuum chamber;
applying a plasma potential; and
sputtering the inert gas into a plasma state.

13. The roll-up electronic piano of claim 4, wherein the keyboard includes a second piezoelectric material that is operative to discontinue a power supply to the keyboard when the keyboard in a predetermined position.

14. The roll-up electronic piano of claim 4, wherein the controller further comprises a selector that is operative to change an active range of the keyboard.

15. The roll-up electronic piano of claim 4, wherein the controller further comprises at least one pedal operative to modify at least one of a magnitude of an audible sound, a length of an audible sound, a magnitude of the sound signal, a length of the sound signal, and timbre.

16. The roll-up electronic piano of claim 4, wherein the controller further comprises a volume control to modify a volume of at least one of an audible sound and a sound signal.

17. The roll-up electronic piano of claim 16, wherein the volume control includes an indicia corresponding to a standard volume range of a real piano.

18. The roll-up electronic piano of claim 4, wherein the controller further includes an analog-to-digital converter.

19. The roll-up electronic piano of claim 4, wherein the keyboard and the controller are adapted to be separable and maintain communication by at least one of a wired method or a wireless method.

20. The roll-up electronic piano of claim 19, wherein the keyboard further includes:
a signal processor that associates a unique identifier to a signal received from at least one of the lower conducting film and the upper conducting film; and
a transmitter that transmits the signal from the keyboard to the controller.

21. The roll-up electronic piano of claim 20, wherein the controller comprises:
a receiver that identifies the unique identifier and receives the signal from the transmitter;
an analog-to-digital converter;
a microprocessor that identifies a magnitude of the force using at least in part the second voltage change; and
a sound chip adapted to generate the sound signal with the predetermined volume corresponding to the magnitude of the force.

22. The roll-up electronic piano of claim 20, wherein the controller includes software capable of performing at least one of identifying the unique identifier of the signal from the transmitter, converting the signal received into a digital signal, determining a magnitude of the force using at least in part the second voltage change, and generating the sound signal with the predetermined volume corresponding to a magnitude of the force.

23. A roll-up electronic piano comprising:
a keyboard comprising:
a piezoelectric material having an electrical resistance that changes in response to a force applied thereto,
at least two printed circuit board plates including a set of electrical contacts corresponding to each key of the keyboard and positioned in proximity to the piezoelectric material,
a shock-absorber transmitting the force to the piezoelectric material if the force is more than a predetermined magnitude;
a controller:
applying an electric current between the printed circuit board plates when the force is transmitted to the piezoelectric material,
determining a magnitude of the force using at least one of an electrical current change and a voltage change after applying the electric current between the printed circuit board plates, and
generating a sound signal with a predetermined volume corresponding to the magnitude of the force; and
a first conducting material and a second conducting material adapted to transmit the electrical current from the piezoelectric material to the controller.

24. The roll-up electronic piano of claim 23, wherein the controller comprises a microprocessor that calculates the magnitude of the force based on at least one of an electrical current change and a voltage change after applying the electric current between the printed circuit board plates, and a sound chip that generates the sound signal with the predetermined volume corresponding to the magnitude of the force.

25. The roll-up electronic piano of claim 23, wherein the sound chip includes a record associating a particular volume of the sound signal with a corresponding magnitude of the force.

26. The roll-up electronic piano of claim 23, wherein the controller includes a record of instruments that includes at least one of a piano, a guitar, a flute, a saxophone, a violin, a mandolin, and a harp.

27. The roll-up electronic piano of claim 23, wherein the piezoelectric material interposes the first conducting material and the second conducting material.

28. The roll-up electronic piano of claim 27, wherein the first conducting material includes an insulator mounted thereto, and the second conducting material includes an insulator mounted thereto, and the printed circuit board plates include an insulator mounted thereto.

29. The roll-up electronic piano of claim 23, wherein the keyboard includes a cover.

30. The roll-up electronic piano of claim 29, wherein the cover includes a plurality of fine grooves fabricated utilizing at least in part the steps of:
injecting an inert gas into a vacuum chamber;
applying a plasma potential; and
sputtering the inert gas into a plasma state.

31. The roll-up electronic piano of claim 23, wherein the keyboard includes a second piezoelectric material that is operative to discontinue a power supply to the keyboard when the keyboard is in a predetermined position.

32. The roll-up electronic piano of claim 23, wherein the controller further comprises a selector operative to modify an active range of the keyboard.

33. The roll-up electronic piano of claim 23, wherein the printed circuit board plates comprise a first printed circuit board plate and a second printed circuit board plate.

34. The roll-up electronic piano of claim 33, wherein a plurality of protrusions are mounted in proximity to the first printed circuit board plate, the plurality of protrusions preventing an electric current from flowing between the first printed circuit board plate and the second printed circuit board plate when no force is applied to the piezoelectric material.

35. The roll-up electronic piano of claim 23, wherein the controller further comprises at least one pedal operative to modify at least one of a magnitude of an audible sound, a length of an audible sound, a magnitude of the sound signal, a length of the sound signal, and timbre.

36. The roll-up electronic piano of claim 23, wherein the controller further comprises a volume control to modify a volume of at least one of an audible sound and the sound signal.

37. The roll-up electronic piano of claim 36, wherein the controller further comprises an indicia corresponding to a standard volume range of a real piano.

38. The roll-up electronic piano of claim 23, wherein the controller further includes an analog-to-digital converter.

39. The roll-up electronic piano of claim 23, wherein the keyboard and the controller are adapted to be separable and maintain communication by at least one of a wired connection and a wireless connection.

40. The roll-up electronic piano of claim 39, wherein the keyboard further comprises:
a signal processor that associates a unique identifier with a signal received from at least one of the first conducting material and the second conducting material; and
a transmitter that transmits the signal from the keyboard to the controller.

41. The roll-up electronic piano of claim 40, wherein the controller includes:
a receiver that identifies the unique identifier and receives the signal from the transmitter;
an-analog-to-digital converter;
a microprocessor that identifies the magnitude of the force using at least one of the electrical current change and the voltage change after applying the electric current between the printed circuit board plates; and
a sound chip adapted to generate the sound signal with the predetermined volume corresponding to the magnitude of the force.

42. The roll-up electronic piano of claim 40, wherein the controller includes software that is capable of performing at least one of:
receiving the signal from the transmitter;
converting the signal received into a digital signal;
determining the magnitude of the force using at least one of the electrical current change and the voltage change after applying the electric current between the printed circuit board plates; and
generating the sound signal with the predetermined volume corresponding to the magnitude of the force.

43. A roll-up electronic piano comprising:
a keyboard comprising a plurality of printed circuit board plates including a set of electrical contacts for each key of the keyboard and a bias operative to filter forces applied to each key of the keyboard to selectively allow predetermined forces to reach a piezoelectric material in electrical communication with at least one of the plurality of printed circuit board plates; and
a controller operative to generate a sound signal based at least in part upon an output from the printed circuit board plates.

44. The roll-up electronic piano of claim 43, wherein the controller includes a sound chip that generates the sound signal based on the output from the printed circuit board plates.

45. The roll-up electronic piano of claim 43, wherein the controller includes a register for instruments that includes at least one of a piano, a guitar, a flute, a saxophone, a violin, a mandolin, and a harp.

46. The roll-up electronic piano of claim 43, wherein a first insulator and a second insulator are at least partially separated by the printed circuit board plates.

47. The roll-up electronic piano of claim 43, further comprising a cover forming an exterior portion of the keyboard.

48. The roll-up electronic piano of claim 47, wherein the cover includes silicon rubber.

49. The roll-up electronic piano of claim 43, wherein the cover includes fine grooves formed using at least in part the steps of:
injecting an inert gas into a vacuum chamber;
applying plasma potential; and
sputtering the inert gas in plasma state.

50. The roll-up electronic piano of claim 43, wherein the keyboard includes a second piezoelectric material operative to discontinue a power supply to the keyboard when the keyboard is in a predetermined position.

51. The roll-up electronic piano of claim 43, wherein the controller further comprises a setting operative to manipulate an active range of the keyboard.

52. The roll-up electronic piano of claim 43, wherein the printed circuit board plates comprise a first plate and a second plate.

53. The roll-up electronic piano of claim 52, wherein a plurality of protrusions interpose the first plate and the second plate and are operative to prevent an electric current between the first plate and the second plate absent at least one of the predetermined forces acting upon a key of the keyboard.

54. The roll-up electronic piano of claim 43, wherein the controller further comprises at least one pedal operative to manipulate at least one of the magnitude of an audible sound, a duration of an audible sound, the magnitude of the sound signal, the duration of the sound signal, and timbre.

55. The roll-up electronic piano of claim 43, wherein the controller further comprises a volume control to manipulate a volume of at least one of an audible sound and the sound signal.

56. The roll-up electronic piano of claim 55, wherein the volume control includes an indication in proximity thereto coinciding with a standard volume range of a real piano.

57. The roll-up electronic piano of claim 43, wherein the controller further includes an analog-to-digital converter.

58. The roll-up electronic piano of claim 43, wherein the keyboard and the controller are adapted to be separable and in communication using at least one of a wired method and a wireless method.

59. The roll-up electronic piano of claim 58, wherein the keyboard further includes:
a signal processor that associates a unique identifier with a signal from at least one of the piezoelectric material and one of the plurality of printed circuit board plates; and
a transmitter that transmits the signal from the keyboard to the controller.

60. The roll-up electronic piano of claim 59, wherein the controller includes:
a receiver that identifies the unique identifier and receives the signal from the transmitter;
an analog-to-digital converter; and
a sound chip adapted to generate the sound signal with a predetermined volume corresponding to the signal from at least one of the piezoelectric material and one of the plurality of printed circuit board plates.

61. The roll-up electronic piano of claim 59, wherein the controller includes software capable of identifying the unique identifier associated with the signal, converting the signal into a digital signal, and generating the sound signal with a predetermined volume.

62. A method of generating sound in a roll-up electronic piano comprising the steps of:
overcoming a bias to deform a piezoelectric material in electrical communication with a controller, the controller adapted to evaluate an output in electrical communication with the piezoelectric material and generate a sound signal in response to the output; and
generating an audible sound with a predetermined volume that corresponds to the output using at least in part the sound signal, where the output is indicative of a magnitude of a force that overcomes the bias to deform the piezoelectric material.

63. A method of generating sound in a roll-up electronic piano comprising the steps of:
overcoming a bias to provide electrical communication between printed circuit board plates including a set of electrical contacts for each key of a keyboard, the electrical contacts being in communication with a controller adapted to evaluate an output in electrical communication with the printed circuit board plates and generate a sound signal in response to the output; and
generating an audible sound with a predetermined volume that corresponds to the output using at least in part the sound signal, where the output is indicative of a magnitude of a force that overcomes the bias to provide electrical communication between a pair of printed circuit board plates.

64. A roll-up electronic piano keyboard comprising:
a plurality of keys;
at least one of a piezoelectric material and printed circuit board plates, where the printed circuit board plates and the piezoelectric material include a set of electrical contacts specific to each key of the keyboard; and
a bias operative to transmit a predetermined force to at least one of the piezoelectric material and the printed circuit board plates.

65. A roll-up electronic piano comprising:
a keyboard comprising:
a plurality of keys,
at least one of a piezoelectric material and printed circuit board plates, where the printed circuit board plates and the piezoelectric material include a set of electrical contacts specific to each key of the keyboard,
a bias operative to transmit a predetermined force to at least one of the piezoelectric material and the printed circuit board plates;
a controller in communication with an output from at least one of the piezoelectric material and the printed circuit board plates, the controller operative to evaluate the output and generate a sound signal; and
a speaker for producing an audible sound using the sound signal, where the audible sound is adapted to mirror a real piano sound based on subjecting one or more keys of a real piano to the predetermined force.
